(19) United States
(12) Patent Application Publication
(10) Pub. No.: US 2005/0084206 A1
(43) Pub. Date: Apr. 21, 2005

(54) Fiberoptic wavelength combiner

(76) Inventors: Mikhail A. Gutin, Albany, NY (US); Boyd V. Hunter, Albuquerque, NM (US); Dennis J. Yost, Los Gatos, CA (US)

Correspondence Address: David W. Collins;Intellectual Property Law, Suite 125B, 75 Calle de las Tiendas, Green Valley, AZ, 85614, US

(21) Appl. No.: 10/686,963

(22) Filed: Oct. 15, 2003

(51) Int. Cl. G02B 6/28

(52) U.S. Cl. 385/24; 385/47

(57) ABSTRACT

A fiberoptic wavelength combiner comprises: a collimating lens having a first surface and a second surface, opposite the first surface; two input optical fibers secured to the first surface, each input optical fiber conducting light at a wavelength that is different from other input optical fibers; a wedged mirror spaced from the second surface, the wedged mirror having a front surface facing the collimating lens and a rear surface, the front surface provided with a first reflective coating and the rear surface provided with a second reflective coating; and an output optical fiber secured to the first surface, whereby light from the input optical fibers is collimated by the lens and made incident on the wedged mirror and its first and second reflective coatings to thereby direct the light back through the collimating lens onto the output optical fiber. Further, a method of aligning the fiberoptic wavelength combiner is provided.

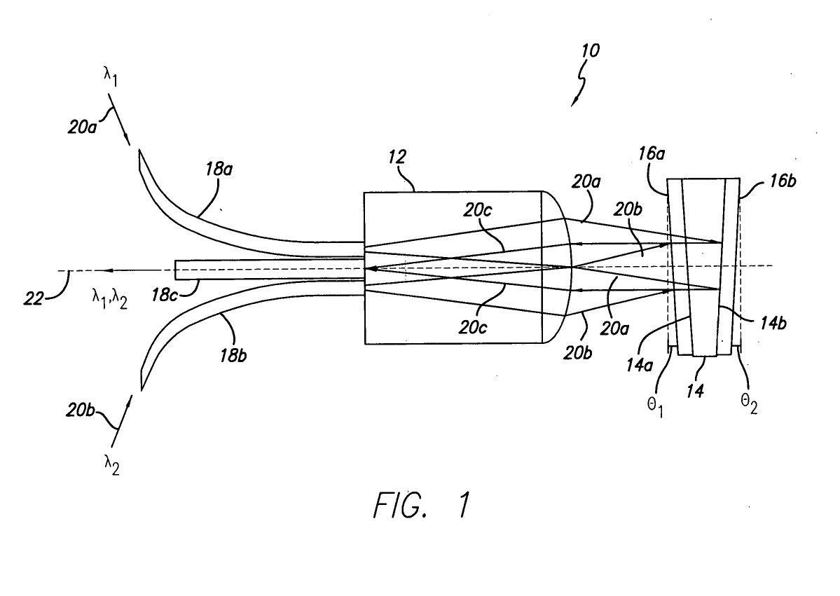

### TECHNICAL FIELD

The present invention relates generally to fiberoptic telecommunications, and, more particularly, to combining two different wavelengths into one fiber.

### BACKGROUND ART

A common task in fiberoptic telecommunications is to provide for input of two different wavelengths from two different sources into one fiber, e.g., a 1550-nm signal and a 980-nm pump. The combination of a dichroic mirror, three fibers, and three collimators is a popular and obvious solution. However, such a combination constitutes a relatively large device that has a significant weight and that is susceptible to shock and vibration.

A need remains for a combiner that is simpler in construction, weighs less than the prior art combination, is less susceptible to shock and vibration than the prior art combination, and has a smaller cross-section.

### DISCLOSURE OF INVENTION

In accordance with an embodiment of the present invention, a fiberoptic wavelength combiner is provided. The combiner comprises:
a collimating lens having a first surface and a second surface, opposite the first surface;
two input optical fibers secured to the first surface, each input optical fiber conducting light at a wavelength that is different from other input optical fibers;
a wedged mirror spaced from the second surface, the wedged mirror having a front surface facing the collimating lens and a rear surface, the front surface provided with a first reflective coating and the rear surface provided with a second reflective coating; and
an output optical fiber secured to the first surface,
whereby light from the input optical fibers is collimated by the lens and made incident on the wedged mirror and its first and second reflective coatings to thereby direct the light back through the collimating lens onto the output optical fiber.

In accordance with another embodiment of the present invention, a method of aligning the fiberoptic wavelength combiner comprises either:
adjusting orientation of the mirror and locations of all optical fibers relative to a center of the first surface of the lens before fusing the optical fibers to the first surface of the lens; or
fusing the optical fibers to the first surface of the lens and then aligning using a length of graded-index fiber.

The fiberoptic wavelength combiner of the present invention is smaller in size than the prior art combination, weighs less, and is less susceptible to shock and vibration. Due to the fewer elements, the combiner of the present invention is also expected to cost less than the prior art combination.

Other objects, features, and advantages of the present invention will become apparent upon consideration of the following detailed description and accompanying drawings, in which like reference designations represent like features throughout the FIGURES.

### BRIEF DESCRIPTION OF THE DRAWINGS

The drawings referred to in this description should be understood as not being drawn to scale except if specifically noted.

The sole FIGURE depicts one embodiment of a fiberoptic wavelength combiner of the present invention.

### BEST MODES FOR CARRYING OUT THE INVENTION

Reference is now made in detail to a specific embodiment of the present invention, which illustrates the best mode presently contemplated by the inventors for practicing the invention. Alternative embodiments are also briefly described as applicable.

A fiberoptic wavelength combiner, utilizing a single collimator, serves the purpose of combining two different wavelengths into one fiber. One implementation of the device is shown in the sole FIGURE. Based on the disclosure herein, it will be readily apparent that other embodiments may also be envisioned.

The device 10 comprises a lens 12, a wedged mirror 14 having a first surface coating 16a on its front surface 1-4a and a second surface coating 16b on its rear surface 14b, and three fibers 18a, 18b, and 18c.

Light 20a, 20b of two different wavelengths, λ₁ and λ₂, respectively, enters the device 10 via optical fibers 18a and 18b. The fibers 18a, 18b are attached to the lens 12, such as by using known laser fusion procedures or other bonding techniques or held in a ferrule to allow an air-spaced collimator design to be used; see, e.g., U.S. Pat. Nos. 6,360,039; 6,217,698; and 6,033,515.

The light 20a, 20b is collimated by the lens 12, and the two collimated beams exit the lens, each at a small angle to the optical axis 22, e.g., 1.8°. The small angle is within the range of 1° to 3°, and preferably within the range of 1.8° to 2°.

The beam angles, which are the result of the lens focal length and the fiber spacing, may be any angle allowed by the optics. However, the reflective coatings may constrain the range of possible angles. For DWDM coatings, 1.8-2 degrees is standard; for a system with a 980 nm pump and another signal in a telecom band, the wavelengths are sufficiently far apart that the long pass/short pass coatings are relatively insensitive to the choice of angle.

The beams 20a, 20b are then incident onto the mirror 14 with its two reflective coatings, 16a, 16b, on its two sides 14a, 14b, respectively. The mirror 14 is wedged in order to direct the light from the two source fibers 18a, 18b onto a common fiber 18c. Additionally, a non-planar surface (not shown) on the mirror 14, such as a sphere, may also be used to alter the beam propagation properties and enhance the efficiency above the results of a simple wedged substrate 14. With regard to the non-planar surface, both surfaces 14a, 14b of the mirror 14 could be concave, for example, to focus light or to reduce power on the lens 12.

The wedge angle θ is twice the angle between the collimated beams 20a, 20b, e.g., 1.8*2=3.60. Wedge angle θ₁=θ₂ if the output optical fiber 18c is centered on the optical axis 22 and if the input optical fibers 18a, 18b are symmetrically disposed about the output optical fiber. Wedge angle θ₁≠θ₂ if the foregoing conditions do not obtain. Coating 16a is highly reflective at wavelength λ₁ and transmits nearly 100% at λ₂. Coating 16b is highly reflective at λ₂. By “highly reflective” is meant at least 99% reflective; by “transmits nearly 100%” is meant at least 99% transmissive:

Due to the forgoing nature of the two coatings, the two beams 20a, 20b are combined as a single exit beam 20c that is directed by the lens 12 onto the output optical fiber 18c.

Alignment of the device 10 is performed using one of two possible methods. According the first method, alignment is done during fabrication by adjusting the orientation of the mirror 14 and locations of the fibers 18a, 18b, 18c relative to the center 22 of the lens surface 12a before fusing. According to the second method, alignment is performed after the fusion of the three fibers 18a, 18b, 18c, using a length of graded-index fiber.

It is understood that the optimal position of each reflective surface 14a, 14b (coating 16a, 16b) is defined by the core-to-core pitch between fibers 18a, 18b, 18c and the focal length of the lens 12. It is possible to provide for near-optimal location of the reflective surfaces 14a, 14b while using the mirror substrate 14 of feasible thickness, because (1) focal lengths of the lens 12 at the two wavelengths are different, resulting from dispersion in the lens material, and (2) fiber 18c, while single-mode of the longer wavelength (e.g., 1550 nm) will be multimode for the shorter wavelength (e.g., 980 nm), which relaxes the requirement on the mirror location for the latter wavelength.

For optical coupling efficiency, telecentricity is required. Thus, each surface of the wedge should be located one focal length (at the wavelength to be reflected by that surface) from the front principal plane of the lens, i.e., the wedge surfaces and the telecentric stops are collocated.

### Industrial Applicability

The fiberoptic wavelength combiner is expected to find use in telecommunications.

Thus, there has been disclosed a fiberoptic wavelength combiner. It will be readily apparent to those skilled in this, art that various changes and modifications of an obvious nature may be made, and all such changes and modifications are considered to fall within the scope of the present invention, as defined by the appended claims.

1. A fiberoptic wavelength combiner comprising:
a collimating lens having a first surface and a second surface, opposite said first surface;
two input optical fibers secured to said first surface, with a first input optical fiber conducting light of wavelength λ₁ and a second input optical fiber conducting light of wavelength λ₂, wherein λ₁ is different than λ₂;
a wedged mirror spaced from said second surface, said wedged mirror having a front surface facing said collimating lens and a rear surface, said front surface provided with a first reflective coating and said rear surface provided with a second reflective coating; and
an output optical fiber secured to said first surface, wherein said output optical fiber is single mode for the longer of said two wavelengths λ₁ and λ₂ and is multimode for the shorter of said two wavelengths,
whereby light from said at least two input optical fibers is collimated by said lens and made incident on said wedged mirror and its first and second reflective coatings to thereby direct said light back through said collimating lens onto said output optical fiber.

2. The combiner of claim 1 wherein light collimated by said lens forms a collimated beam for each input optical fiber, and where each collimated beam exits said lens at an angle within a range of 1° to 3°.

3. The combiner of claim 2 wherein said angle is within a range of 1.8° to 2°.

4. The combiner of claim 2 wherein said wedged mirror has a wedge angle, relative to a central optical axis through said lens, that is twice said angle of said exiting collimated beam.

5. (canceled)

6. The combiner of claim 1 wherein said first reflective coating is at least 99% reflective at wavelength λ₁ and transmits at least 99% at wavelength λ₂ and wherein said second reflective coating is at least 99% reflective at wavelength λ₂.

7. (canceled)

8. A method of aligning a fiberoptic wavelength combiner comprising:
a collimating lens having a first surface and a second surface, opposite said first surface;
two input optical fibers secured to said first surface, with a first input optical fiber conducting light of wavelength λ₁ and a second input optical fiber conducting light of wavelength λ₂, wherein λ₁ is different than λ₂;
a wedged mirror spaced from said second surface, said wedged mirror having a front surface facing said collimating lens and a rear surface, said front surface provided with a first reflective coating and said rear surface provided with a second reflective coating; and
an output optical fiber secured to said first surface, wherein said output optical fiber is single mode for the longer of said two wavelengths λ₁ and λ₂ and is multimode for the shorter of said two wavelengths,
whereby light from said at least two input optical fibers is collimated by said lens and made incident on said wedged mirror and its first and second reflective coatings to thereby direct said light back through said collimating lens onto said output optical fiber, said method comprising either:
adjusting orientation of said mirror and locations of all optical fibers relative to a center of said first surface of said lens before fusing said optical fibers to said first surface of said lens; or
fusing said optical fibers to said first surface of said lens and then aligning using a length of graded-index fiber.

9. The method of claim 8 wherein light collimated by said lens forms a collimated beam for each input optical fiber, and where each collimated beam exits said lens at an angle within a range of 1° to 3°.

10. The method of claim 9 wherein said angle is within a range of 1.8° to 2°.

11. The method of claim 9 wherein said wedged mirror has a wedge angle, relative to a central optical axis through said lens that is twice said angle of said exiting collimated beam.

12. (canceled)

13. The method of claim 8 wherein said first reflective coating is at least 99% reflective at wavelength λ₁ and transmits at least 99% at wavelength λ₂ and wherein said second reflective coating is at least 99% reflective at wavelength λ₂.

14. (canceled)
